(19) United States
(12) Patent Application Publication
(10) Pub. No.: US 2003/0014579 A1
(43) Pub. Date: Jan. 16, 2003

(54) Communication controller and method of transforming information

(75) Inventors: Hans-Peter Heigl, Poing (DE); Mark Jonas, Munchen (DE)

Correspondence Address: Jim Cligan, Motorola, Inc., Austin Intellectual Property Law Section, 7700 West Parmer Lane, Austin, TX, 78729, US

(73) Assignee: Motorola, Inc

(21) Appl. No.: 09/903,178

(22) Filed: Jul. 11, 2001

(51) Int. Cl. G06F 13/42

(52) U.S. Cl. 710/105

(57) ABSTRACT

A communication controller (20) for communication on at least one communication bus (12, 14), each communication bus transferring a data stream according to a communication protocol, the communication controller comprising a communication handler (17) coupled to the at least one communication bus adapted to be programmable to perform transformations of the data stream. The communication controller is programmable on bit-level and allows updates/changes of the communication protocol in existing systems without changing the hardware. It further allows to use one communication controller type for several buses/communication protocols.

### FIELD OF THE INVENTION

The present invention relates to means and methods for transforming information transferred within a communication network having several communication units according to a communication protocol.

### BACKGROUND OF THE INVENTION

In a communication network information is transferred between several communication units, which are connected by at least one communication bus. Such a channel is usually a serial communication bus on which a data stream is transferred according to a communication protocol. Especially in the automotive industry nowadays there are several different serial channels employed, some of them can even be connected to the same communication unit. The information to be exchanged between different communication units is in the form of logical bits and bytes, which have a special meaning. The communication units act to the information with respect to this meaning. On the other hand, within the communication network are transferred electrical signals, which represent the information bits in electrical form such that a safe communication is possible. A communication controller is a device, which transforms the electrical signals having a time-dependence into electrical states representing logical bits. Communication controllers according to the Prior Art are hardware-specific with respect to the communication protocol or protocols employed.

In a situation as within the automotive industry, where one controller shall communicate on different channels with different communication protocols it is a burden for the semiconductor manufacturer to provide different communication controllers for different channels. Such communication controller can also be a part of a microcontroller and in this case there have to be provided a set of microcontrollers with the same microcontroller processing unit and different communication controllers. This plurality of versions makes the microcontroller unnecessarily expensive. Further, protocol details change quite frequently so that adapting of the hardware according to the actual protocol version might be necessary.

There is a need for a communication controller, which is able to serve many existing or new communication protocols and can be adapted to modifications of the communication protocols.

### BRIEF DESCRIPTION OF THE DRAWINGS

FIG. 1 is a simplified schematic diagram of a communication controller according to the invention for one serial bus—FIG. 1A—or several serial buses—FIG. 1B;

FIG. 2 is a simplified schematic diagram of a communication handler employed in a communication controller according to the present invention;

FIG. 3 is a simplified schematic diagram of a communication controller according to another embodiment of the present invention;

FIG. 4 is a simplified schematic diagram of a microcontroller unit employing a communication controller according to an embodiment of the present invention;

FIG. 5 is a schematic diagram visualizing data representation on a communication bus;

FIG. 6 is a flow diagram of a method according to an embodiment of the invention;

FIG. 7 is a flow diagram of a method according to an embodiment of the invention receiving serial data on a communication bus; and

FIG. 8 is a flow diagram of a method according to an embodiment of the invention sending serial data on a communication bus.

### DETAILED DESCRIPTION OF THE PREFERRED EMBODIMENT

It is an advantage of the present invention to provide a communication controller, which is hardware-independent from a communication protocol and which can be modified by software to serve several communication protocols. It is a further advantage of the invention that the communication controller according to the invention can be adapted to future communication protocols. Microcontroller units employing a communication controller according to the invention can have a much higher computation power and/or less energy consumption than current microcontroller units because a larger amount of computation work is handled by the communication controller and leaves the central processing unit of the microcontroller more time for other tasks. Another advantage of the invention is that a communication handler of the communication controller can be programmed to transform a data stream on bit-level.

Details of the invention will be explained with respect to embodiments referring to the CAN communication protocol standard of the automotive industry. Other communication protocol may have different details but those skilled in the art can easily make the specific adaptations. A serial communication bus has the feature that data information arrives serially and includes different realizations such as a one-wire bus, a two-wire bus, or a bus with an additional control line.

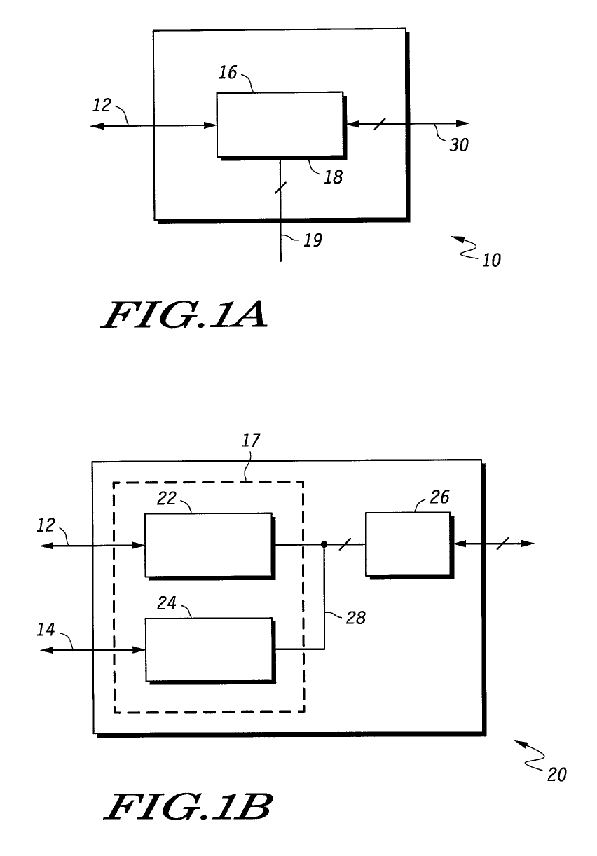

FIG. 1 shows a very simple communication controller according to the invention for one serial bus in FIG. 1A or several serial buses in FIG. 1B. FIG. 1A shows communication controller 10 for communication on serial communication bus 12 transferring a data stream according to a communication protocol. Communication controller 10 comprises communication handler 16, which is adapted to be programmable to perform transformations of the data stream according to a selected communication protocol. More specifically, communication handler 16 comprises channel handler 18 being programmed to transform the data stream of communication bus 12, according to different protocols. Channel handler 18 is coupled to parallel external bus 30. Channel handler 18 is further coupled to instruction bus 19, which extends outside of communication controller 10.

Program instructions specific to communication protocols can be rapidly loaded via instruction bus 19 directly from outside into the channel handler of communication handler 16. Program instructions can be stored in a permanent or non-permanent memory/register.

A serial data stream arriving at communication controller 10 on communication bus 12 is typically a time-dependent voltage signal changing between two voltage levels on flanks, wherein the distances in time between the flanks contains information in encoded form according to the actual communication protocol. The distances in time of the flanks are only roughly defined because they are generated by different communication units with individual internal clocks that are allowed to differ within boundaries given by the communication protocol standard. The channel handler 18 scans the time-dependent voltage signal and identifies logical bits of information according to the program instructions specific to the actual communication protocol. The channel handler 18 further identifies logically relating groups of data bits, usually bytes, and transfers these to parallel external bus 30.

A parallel data stream arriving at communication controller 10 on parallel external channel 30 is transformed by the channel handler 18. This channel handler 18 generates and applies to the serial communication bus 12 a time-dependent voltage signal from the data stream according to the program instructions specific to the actual communication protocol. Thus, the signal put on the serial communication bus 12 complies with the actual communication protocol.

FIG. 1B shows communication controller 20 for communication on each of serial communication buses 12, 14 transferring a data stream according to a communication protocol. Communication controller 10 comprises communication handler 17, which is adapted to be programmable to perform transformations of the data stream according to a selected communication protocol. More specifically, communication handler 17 comprises channel handlers 22, 24 being programmed to transform the data streams of serial communication buses 12, 14, respectively, according to different protocols. Communication controller 10 has further data I/O interface 26 coupled to channel handlers 22, 24 by internal bus 28 and coupled to a parallel external bus 30.

Buses with identical reference numbers 12 and 30 are identical in both FIG. 1A and FIG. 1B. One difference between communication handler 16 and communication handler 17 is that the latter has two channel handlers 22, 24, which can transfer simultaneously data on serial communication buses 12, 14, respectively. Data I/O interface 26 grants access to internal bus 28 to one of serial communication buses 12, 14 at a time such that the data on bus 30 are assigned the correct one of serial communication buses 12, 14 in any direction of data flow. Data can be temporarily buffered if needed. Another difference between communication handler 16 and communication handler 17 is that communication handler 17 gets its instructions from external bus 30 via data I/O interface 26 and internal bus 28.

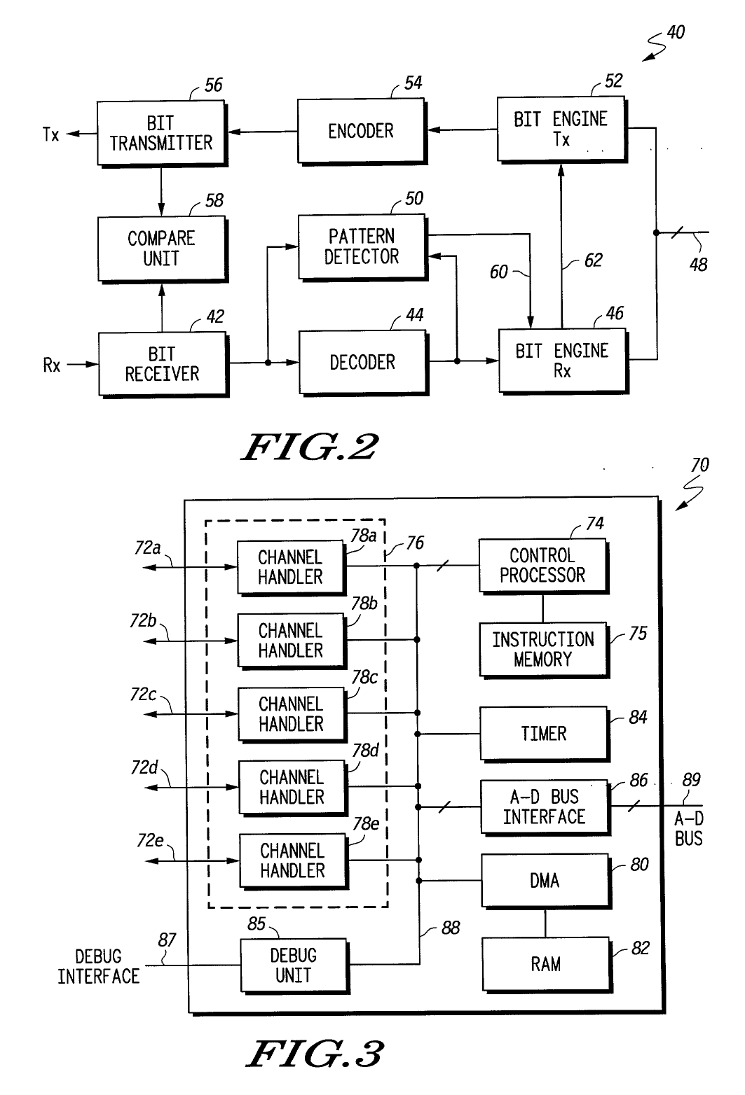

FIG. 2 shows schematically channel handler 40 employed in a typical communication controller according to the present invention. Channel handler 40 comprises in a receiving section bit receiver 42 coupled to external serial bus line Rx, decoder 44 coupled to bit receiver 42, bit engine Rx 46 coupled to decoder 44 and internal parallel bus 48, and pattern detector 50 coupled to bit receiver 42, decoder 44 and bit engine Rx 46. Channel handler 40 comprises in a transmitting section bit engine Tx 52 coupled to internal parallel bus 48 and bit engine Rx 46, encoder 54 coupled to engine Tx 52, and bit transmitter 56 coupled to encoder 54 and external serial bus line Tx. Channel handler 40 comprises further compare unit 58 coupled to bit receiver 42 and bit transmitter 56. Further control lines are omitted for reasons of simplicity.

Channel handler 40 works as follows. A serial data stream on a communication bus arrives on external serial bus line Rx. Between the communication bus and bus line Rx there is usually a line interface (not shown) that separates incoming data from outgoing data and protects communication controller 10 of high voltage peaks. Such a line interface can also perform a conversion between optical and electrical signals if an optical bus is used. The serial data stream at arriving at Rx is typically a time-dependent voltage signal changing between two voltage levels on flanks. Bit receiver 42 of channel handler 40 is programmable and scans the time-dependent voltage signal at Rx and identifies logical bits of information according to the program instructions specific to the actual communication protocol. Bit receiver 42 is a simple asynchronous/synchronous receiver that is able to sample bits from the Line Interface. This can be done by using an internal baud rate generator or a dedicated clock line (not shown). In asynchronous mode the device is also able to do hard or soft synchronization on data line transitions. The decision on which transitions to synchronize can done by bit engine Rx 46 instead of bit receiver 42. The output of bit receiver 42 is a clocked serial bit stream containing the sampled bits. Arrows show the flow of information.

Decoder 44 is here a programmable module that can be programmed to decode various popular coding schemes like NRZI Mark or Bit Stuffing. Input and output of the module is a clocked serial bit stream and output is a decoded serial bit stream.

Pattern detector 50 is a programmable module that can be a preamble or a Start-of-Frame detector and is responsible for detecting frame preambles or a Start-of-Frame marker.

Bit engine Rx 46 is a programmable module that is responsible for converting a clocked serial bit stream into data fields of a predefined logical meaning in positions defined by the protocol. It uses preamble or Start-of-Frame information of Pattern detector 50 provided via information line 60. Bit engine Rx 46 can also react on certain bus conditions and errors. The data fields are outputted on internal parallel bus 48 of the communication controller.

Parallel data arrives on internal parallel bus 48 at bit engine Tx 52. Bit engine Tx 52 converts the parallel data into a clocked serial bit stream.

Encoder 54 is here a programmable module that can be programmed to encode serial clocked bit streams with popular coding schemes like NRZI Mark or Bit Stuffing. Input of the module is a clocked serial bit stream and output is an encoded serial bit stream.

Bit transmitter 56 is the counterpart to bit receiver 42 and has to convert the clocked serial bit stream coming from encoder 54 to an asynchronous or synchronous Tx signal for the line interface (not shown) according to the communication protocol. It can have its own baud rate generator but it can also use the baud rate generated by the Bit Receiver.

Compare unit 58 is responsible for comparing the data sent out with the incoming data. This task is needed very often for protocols where all nodes are using a common bus, such as in CAN. With a compare unit it is possible to detect bus failures, arbitration loss and so on.

Control line 62 which can be used for acknowledgement and allows to send a very fast response, as required e.g. by CAN.

In this embodiment all components have been described to be programmable in order to show the advantages of the flexibility achieved by each component being programmable. However, those skilled in the art will see that it is not necessary that every component is programmable. The invention is useful if at least one of such components is programmable. This allows an implementation of a protocol specific data transformation after production of the communication controller. The communication handler is suitable to support event-triggered or time-triggered protocols, wherein the controller can access or provide the necessary timing information.

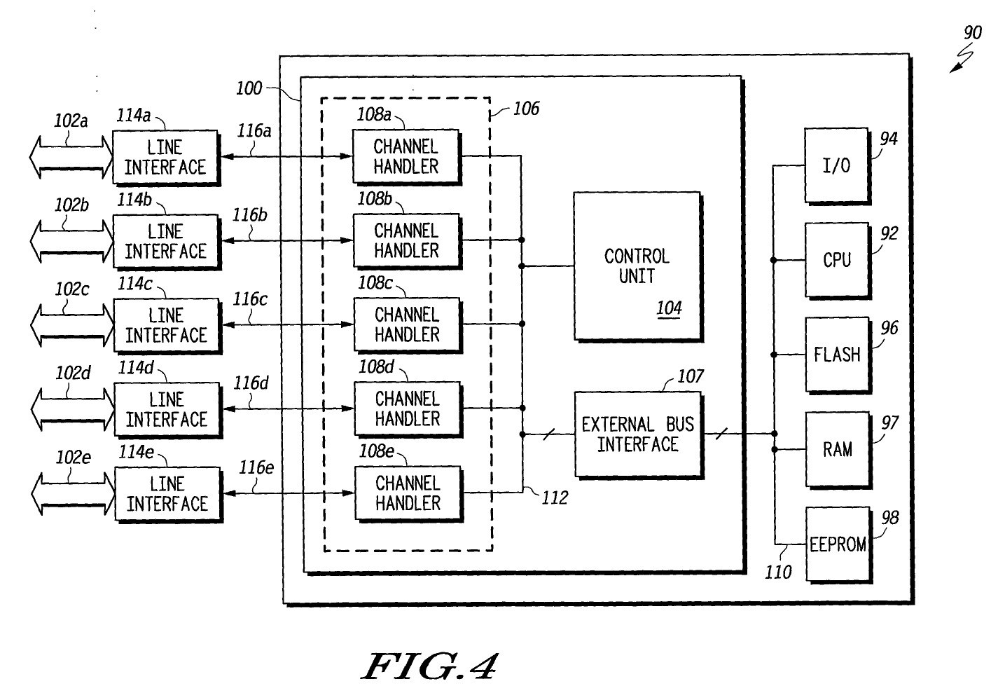

FIG. 3 shows communication controller 70 according to the present invention for communication on each of serial communication buses 72a . . . 72e transferring a data stream according to a communication protocol. Communication controller 70 comprises control unit 74 coupled to instruction memory 75 and to communication handler 76. Communication handler 76 is adapted to be programmable to perform transformations of the data stream according to a selected communication protocol. More specifically, communication handler 76 comprises channel handlers 78a . . . 78e being programmed to transform the data streams of communication buses 72a . . . 72e respectively, according to different protocols. Communication controller 70 comprises also DMA controller 80 coupled to RAM 82, timer 84, debug unit 85 coupled to external debug interface 87, and address-data I/O interface 86 coupled to external address-data-bus 89. Internal address-data-bus 88 couples control unit 74, channel handlers 78a . . . 78e of communication handler 76, DMA controller 80, timer 84, debug unit 85, and address-data I/O interface 86 to each other.

Program instructions specific to communication protocols can be loaded via external address-data-bus 89 into RAM 82 and from there or directly from outside into a channel handler of communication handler 76.

In this embodiment there is a common internal address-data-bus 88 for both instructions and data instead of separate instruction bus 19 and data line 28 of FIG. 1. The channel handlers work in principle as described above. The channel handlers 78a . . . 78e receive time-dependent voltage signals and provide data fields to internal address-data-bus 88 there from and vice versa according to the program instructions specific to the actual communication protocol.

Control unit 74, here a RISC processor, controls the programming and work of communication handler 76. Additionally, control unit 74 transforms data of the data stream. Specifically, control unit 74 performs the transformation between the data fields provided by communication handler 76 and data frames that represent the communicated message, for both directions of data flow.

Debug unit 85 coupled allows to directly debug the programs involved from the outside via external debug interface 87, including programs for the channel handlers and programs for the RISC processor.

The communication controller is programmable on bit-level and allows updates/changes of the communication protocol in existing systems without changing the hardware. It further allows to use one communication controller type for several buses/communication protocols.

The DMA controller and RAM allows to intermediate storing of information. Usually, the data processing and data transfer on internal address-data-bus 88 is much faster than on the serial data buses. This allows operating different communication channels with different data streams and different communication protocols simultaneously.

FIG. 4 shows microcontroller unit 90 comprising CPU 92, input-output unit 94, flash memory 96, RAM 97, EEPROM 98 and serial communication buses 102a . . . 102e transferring a data stream according to a communication protocol. Communication controller 100 comprises control unit 104 coupled to communication handler 106. Communication handler 106 is adapted to be programmable to perform transformations of the data stream according to a selected communication protocol. More specifically, communication handler 16 comprises channel handlers 108a . . . 108e being programmed to transform the data streams of communication buses 102a . . . 102e respectively, according to different protocols. Communication controller 100 comprises also address-data I/O interface 107 coupled to microcontroller address-data-bus 110. Internal address-data-bus 112 couples control unit 104, channel handlers 108a . . . 108e of communication handler 106, and address-data I/O interface 107 to each other.

Program instructions specific to communication protocols can be loaded via microcontroller address-data-bus 110 via address-data I/O interface 107 into any of channel handlers 108a . . . 108e of communication handler 106 or control unit 104. Control unit 104, here a RISC processor, controls the programming and work of communication handler 106. Additionally, control unit 104 transforms data of the data stream. Specifically, control unit 104 performs the transformation between the data fields provided by communication handler 106 and data frames that represent the communicated message, for both directions of data flow. Communication controller 100 has also a memory (not shown) allowing intermediate storing of information. The data processing by communication handler 106 and control unit 104 and also the data transfer on internal address-data-bus 112 is much faster than on the serial data buses. This allows operating different communication channels with different data streams and different communication protocols simultaneously.

Here, line interfaces 114a . . . 114e of optical/electrical serial communication buses 102a . . . 102e are shown which perform a conversion between signals and separate incoming data from outgoing data. The channel handlers work in principle as described above.

Incoming messages arriving in form of optical/electrical signals on communication buses 102a . . . 102e are transformed by line interfaces 114a . . . 114e into time-dependent voltage signals on bus sections 116a . . . 116e. Channel handlers 108a . . . 108e receive the these time-dependent voltage signals and provide data fields to control unit 104 via parallel internal address-data-bus 112 according to the program instructions specific to the actual communication protocol. Control unit 104 transforms the data fields and generates there from data frames that represent the communicated message. Control unit 104 transfers the data frames via address-data I/O interface 107 to CPU 92, which uses the message and executes it.

Outgoing messages for a selected one of the communication buses 102a . . . 102e are generated by CPU 92 in the form of data frames. CPU 92 transfers the data frames via address-data I/O interface 107 to control unit 104. Control unit 104 separates data fields form the data frames and transfers the data fields to a respective one of channel handlers 108a . . . 108e associated to the selected one of the communication buses 102a . . . 102e. The channel handler 108a . . . 108e transforms the data fields into time-dependent voltage signals according to the program instructions specific to the actual communication protocol. The line interface 114a . . . 114e on the selected bus converses the time-dependent voltage signals into optical/electrical signals and sends these on the selected bus. Thus, the outgoing message is sent.

It is clear that CPU 92 is relieved from a lot of communication-related computing by communication controller 100. This allows both energy saving by slower clock rates and/or higher performance by using the additional CPU computing capacity no longer needed for communication-related computing.

Those skilled in the art will know that the invention has a great variety of realizations. The number and kind of communication buses can vary (optical, electrical, 1-wire, 2-wire . . . ), the buses being independent from each other. A message can be received on one bus and be sent on another bus by the communication controller or the microcontroller. Different kinds of internal buses can be used. A microcontroller might comprise a programmable communication controller without control unit.

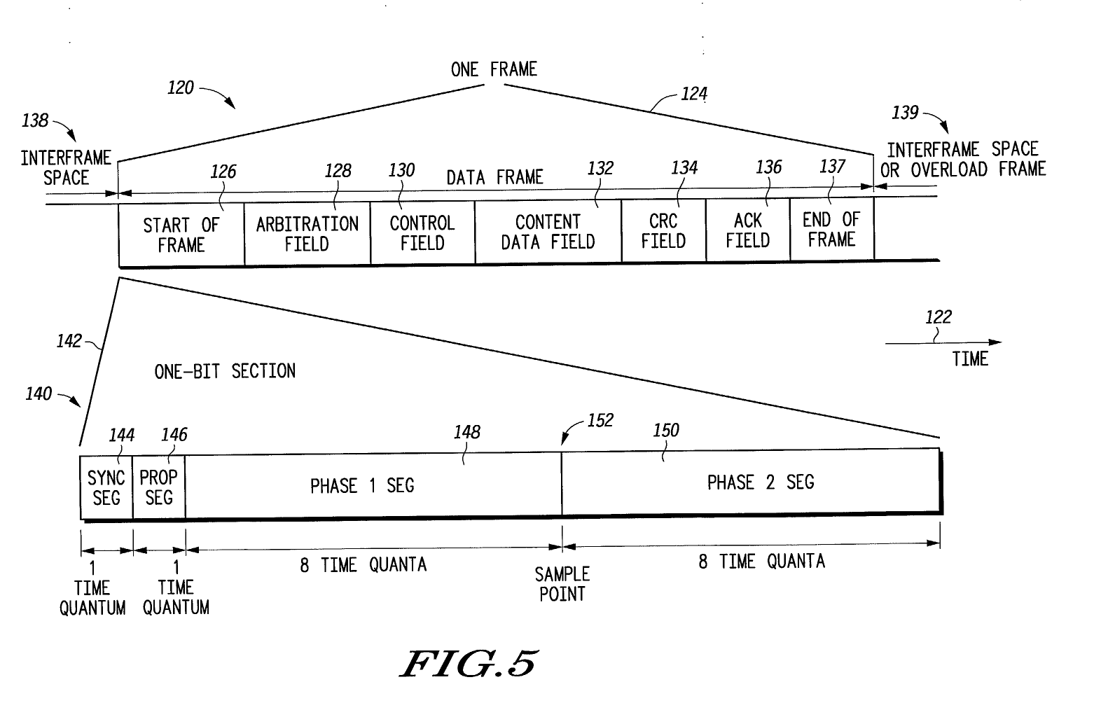

FIG. 5 gives an example of a data representation of data on a serial bus according to a CAN protocol. A communication bus is used to transfer a specified information content between electronic devices. The specified information content is encoded in data units, messages, which are transferred on the bus according to a communication protocol. A message has different fields with logical content of different specified length as specified in the communication protocol. These are the data field containing the whole or part of the information content to be exchanged and several transfer-specific data fields for providing a correct data transfer. A communication controller takes care of dealing with the transfer-specific tasks of the communication.

A data stream, represented by data stream section 120 passes along time axis 122. In the upper part of FIG. 5 data stream section 120 is shown as a message having parts with specified information content, encoded in data frame 124. Such a message contains content information to be exchanged between electronic devices, and additional handling information according to a communication protocol. In the lower part of FIG. 5 a time-dependent voltage signal 140 comprising of the voltage signal representing a single data bit. Each information bit of the data stream is transferred as such a section of the voltage signal. Such a voltage signal is received from or sent to a line interface.

The relation between voltage signal and message is explained by an incoming message, starting with a typical time-dependent voltage signal coming from a line interface. The voltage changes between two voltage levels on flanks, wherein the distances in time between the flanks contain information in encoded form according to the actual communication protocol. The time is dissected in units called time quantum. In the example in FIG. 5 each bit is encoded in one-bit section 142 of the voltage signal being 18 time quanta long. One-bit section 142 comprises several segments, namely Sync segment 144 for synchronization 1 time quantum long, Prop segment 146 being 1 time quantum long and a data segment comprising phase 1 segment 148 being 8 time quanta long and phase 2 segment 150 being 8 time quanta long. The information bit is sampled at sample point 152 of the data segment, which is in the middle of the data segment between phase 1 and phase 2 segments. The voltage should be constant over the data segment.

Thus, with respect to FIG. 2, bit receiver 42 samples a sequence of voltage levels at correct sample points and outputs these as a clocked serial bit stream. Decoder 44 decodes this stream and outputs a clocked serial bit stream. Pattern detector 50 watches for a predefined pattern indicating a preamble or a Start-of-Frame marker. Bit engine Rx 46 collects the encoded bits, identifies data fields and provides these on a parallel bus.

Back to FIG. 5, data fields are SOF (start-of-frame) field 126, arbitration field 128, control field 130, content data field 132, CRC (cyclic redundancy check) field 134, ACK field 136, and EOF (end-of-frame) field 137. SOF field 126 is used to identify the begin of a message, arbitration field 128 is used to arbitrate for the communication bus, control field 130 allows some control, and content data field 132 contains the information to be exchanged. CRC field 134 and ACK field 136 are used to check correct data transfer, and EOF field 137 is used to identify the end of a message. Between frames can be interframe space 138 and immediately after a frame, at 139, can be an interframe space or an overload frame. Overload frames are used if the content data does not fit into one content data field.

Thus, with respect to FIG. 2, the data fields can be outputted directly or can be grouped to a frame by a control unit like control unit 74 or control unit 104.

FIG. 6 shows flow diagram 160 of a method of using a communication controller for communication on at least one communication bus, each communication bus transferring a data stream according to a communication protocol, the communication controller comprising a communication handler coupled to the at least one communication bus adapted to be programmable to perform transformations of the data stream. Messages are to be transferred on a communication bus which is already identified. The method starts at 162 with the step selecting a communication protocol, step 164, for communication on the identified communication bus. Then follows programming the communication handler, step 166, with instructions to perform transformations of the data stream according to the selected communication protocol. Next, receiving electrical signals, step 168, which signals represent data of the data stream. This is understood in a broad sense including both directions of information flow, i.e. time-dependent voltage signals received on a serial bus and signals on a parallel bus to be sent on a serial bus. Then, transforming the electrical signals, step 170, by the communication handler according to the programmed instructions.

According to a preferred embodiment of the invention the method further comprises re-programming the communication handler, step 172 with instructions to enable it to perform transformations of the data stream according to a re-selected communication protocol, which is different from the previously selected communication protocol, which was selected in step 164. Then, receiving electrical signals, step 174, which signals represent data of the data stream, and transforming the electrical signals, step 176, by the communication handler according to the programmed instructions, can be performed. By the re-programming of the communication handler an existing system can be updated to a modified protocol, or even changed to a different protocol.

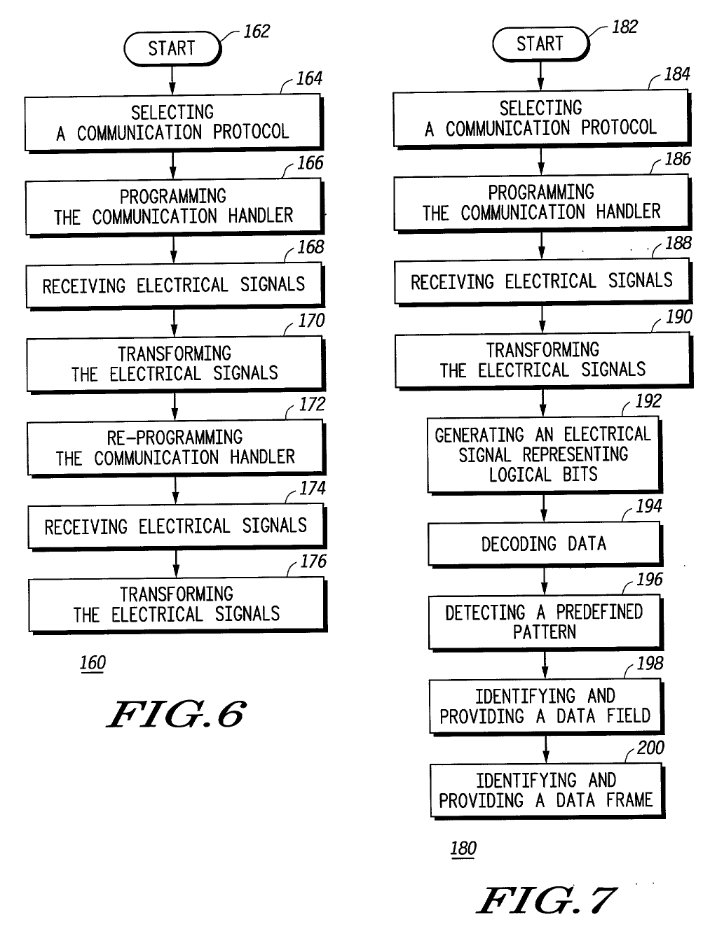

In FIG. 7 flow diagram 180 shows a method according to an embodiment of the invention in detail with respect to incoming data on a serial bus. The method starts at 182 similar to flow diagram 180 of FIG. 6 with the step selecting a communication protocol, step 184, for communication on the identified communication bus. Then follows programming the communication handler, step 186, with instructions to perform transformations of the data stream according to the selected communication protocol. Next, receiving electrical signals, step 188, which signals represent data of the data stream. Then, transforming the electrical signals, step 190, by the communication handler according to the programmed instructions. The transformation of the electrical signals comprises the sub-steps

generating an electrical signal representing logical bits, step 192, from a voltage signal having transitions between voltage levels received on the communication bus according to the communication protocol;

decoding data, step 194, of the data stream;

detecting a predefined pattern, step 196, in the data of the data stream;

identifying and providing a data field, step 198, of logical bits received serially on the communication bus and/or providing for sending serially on the communication bus groups of logical bits provided as parallel data;

identifying and providing a data frame, step 200, representing a message from data fields of logical bits and/or identifying and providing fields of logical bits from a data frame representing a message.

Steps 192, 194, 196, 198, 200 are independent improvements of a method according to the invention as can be seen in the light of FIG. 2 as described above. Steps 192, 194, 196, and step 198 for small data fields are preferably carried out by the communication handler. Step 198 for large data fields and step 200 are preferably carried out outside of the communication handler.

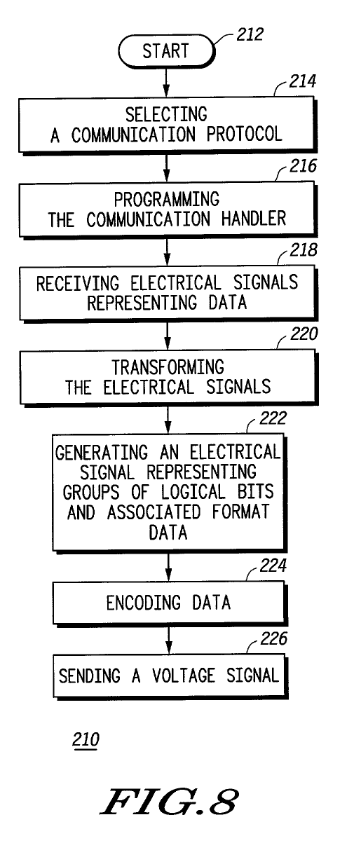

FIG. 8 shows flow diagram 210 of a method according to an embodiment of the invention in detail with respect to outgoing data on a serial bus. The method starts at 212 similar to flow diagram 180 of FIG. 6 with the step selecting a communication protocol, step 214, for communication on the identified communication bus. Then follows programming the communication handler, step 216, with instructions to perform transformations of the data stream according to the selected communication protocol. Next, receiving electrical signals, step 218, which signals represent a data frame of the data stream. Then, transforming the electrical signals, step 220, by the communication handler according to the programmed instructions. The transformation of the electrical signals comprises the sub-steps

Generating an electrical signal representing groups of logical bits and associated format data, step 222;

encoding data, step 224, of the data stream;

sending a voltage signal, step 226, having transitions between voltage levels on the communication bus generated from an electrical signal representing logical bits, according to the communication protocol.

Steps 222, 224, 226, are independent improvements of a method according to the invention as can be seen in the light of FIG. 2 as described above. The actual meaning of the steps 218 to 226 depends on the physical implementation. That is, if the communication controller has a control unit, such as control units 74 or 104 of FIGS. 3 or 4, respectively, the communication controller can receive a data frame in step 218 and separate it into fields in step 220, whereas if the communication controller has no control unit, such as communication controllers 10 or 20 of FIGS. 1, the communication controller can receive a data field in step 218. With respect to FIG. 2 and FIG. 5 method step 222 can include that bit engine Tx 52 generates SOF field 126, CRC field 134, ACK field 136 and EOF field 137, whereas fields 128, 130, and 132 are provided from outside the communication handler.

Advantageously, any of the methods described above is carried out by a communication controller within a microcontroller.

In the foregoing detailed description of the preferred embodiment, reference is made to the accompanying drawings, which form a part hereof, and in which are shown by way of illustration specific embodiments in which the invention can be practiced. These embodiments have been described in sufficient detail to enable those skilled in the art to practice the invention, and it is to be understood that other embodiments can be utilized and that logical, mechanical and electrical changes can be made without departing from the spirit and scope of the present invention. The foregoing detailed description is, therefore, not to be taken in a limiting sense, and the scope of the present inventions is defined only by the appended claims.

Reference Numbers

communication controller 10, 20

serial communication buses 12, 14

communication handler 16, 17

channel handlers 18, 22, 24

instruction bus 19

data I/O interface 26

internal bus 28

parallel external bus 30

channel handler 40

bit receiver 42

decoder 44

bit engine Rx 46

internal parallel bus 48

pattern detector 50

bit engine Tx 52

encoder 54

bit transmitter 56

compare unit 58

information line 60

Control line 62

communication controller 70

communication buses 72a . . . 72e

control unit 74

instruction memory 75

communication handler 76

channel handlers 78a . . . 78e

DMA controller 80

RAM 82

timer 84

debug unit 85

address-data I/O interface 86

external debug interface 87

Internal address-data-bus 88

external address-data-bus 89

microcontroller unit 90

CPU 92

input-output unit 94

flash memory 96

RAM 97

EEPROM 98

communication controller 100

communication buses 102a . . . 102e

control unit 104

communication handler 106

address-data I/O interface 107

channel handlers 108a . . . 108e

microcontroller address-data-bus 110

internal address-data-bus 112

line interfaces 114a . . . 114e

bus sections 116a . . . 116e

data stream section 120

time axis 122

data frame 124

start-of-frame field 126

arbitration field 128

control field 130

content data field 132

CRC field 134

ACK field 136

end-of-frame field 137

space 138

immediately after a frame, at 139

voltage signal 140

one-bit section 142

Sync segment 144

Prop segment 146

phase 1 segment 148

phase 2 segment 150

sample point 152

flow diagram 160

method starts at 162

selecting a communication protocol, step 164

programming the communication handler, step 166

receiving electrical signals, step 168

transforming the electrical signals, step 170

re-programming the communication handler, step 172

flow diagram 180

method starts at 182

selecting a communication protocol, step 184

programming the communication handler, step 186

receiving electrical signals, step 188

transforming the electrical signals, step 190

generating an electrical signal step 192

decoding data, step 194,

detecting a predefined pattern, step 196

identifying and providing a data field, step 198

identifying and providing a data frame, step 200

flow diagram 210

method starts at 212

programming the communication handler, step 216

receiving electrical signals, step 218

transforming the electrical signals, step 220

identifying and providing fields of logical bits, step 222

providing groups of logical bits, step 224

encoding data, step 226

sending a voltage signal, step 228

1. A communication controller for communication on at least one communication bus, each communication bus transferring a data stream according to a communication protocol, the communication controller comprising a communication handler coupled to the at least one communication bus adapted to be programmable to perform transformations of the data stream.

2. The communication controller of claim 1, wherein the communication handler comprises a programmable decoder and/or encoder.

3. The communication controller of claim 1, wherein the communication handler comprises at least one programmable bit engine.

4. The communication controller of claim 1, wherein the communication handler comprises a programmable bit receiver and/or a programmable bit transmitter.

5. The communication controller of claim 1, wherein the communication handler comprises a programmable pattern detector.

6. The communication controller of claim 1, wherein the communication handler is adapted to be programmable to perform transformations of the data stream on bit-level.

7. The communication controller of claim 1, comprising a communication control unit for controlling the communication handler.

8. The communication controller of claim 1, comprising a memory for storing instructions to perform transformations of the data stream according to several communication protocols.

9. The communication controller of claim 1, comprising a debug unit.

10. The communication controller of claim 1, comprising a peripheral channel connection for rapid loading of instructions to perform transformations of the data stream according to custom protocols.

11. A microcontroller unit comprising the communication controller of claim 1.

12. The microcontroller unit of claim 11, adapted to communicate on several communication buses simultaneously, each communication bus transferring a data stream according to a respective communication protocol.

13. A method of using a communication controller for communication on at least one communication bus, each communication bus transferring a data stream according to a communication protocol, the communication controller comprising a communication handler coupled to the at least one communication bus adapted to be programmable to perform transformations of the data stream, the method comprising the steps of
a. selecting a communication protocol;
b. programming the communication handler with instructions to perform transformations of the data stream according to the selected communication protocol;
c. receiving electrical signals representing data of the data stream;
d. transforming the electrical signals representing data of the stream by the communication handler according to the programmed instructions.

14. The method of claim 13, further comprising the step of re-programming the communication handler with instructions to enable it to perform transformations of the data stream according to a re-selected communication protocol which is different from the previously selected communication protocol.

15. The method of claim 13, further comprising the step of generating an electrical signal representing logical bits from a voltage signal having transitions between voltage levels received on the communication bus and/or sending a voltage signal having transitions between voltage levels on the communication bus generated from an electrical signal representing logical bits, according to the communication protocol.

16. The method of claim 13, further comprising the step of decoding/encoding data of the data stream.

17. The method of claim 13, further comprising the step of detecting a predefined pattern in the data of the data stream.

18. The method of claim 13, further comprising the step of identifying and providing as parallel data a data field of logical bits received serially on the communication bus and/or providing for sending serially on the communication bus groups of logical bits provided as parallel data.

19. The method of claim 18, further comprising the step of identifying and providing a data frame representing a message from data fields of logical bits and/or identifying and providing fields of logical bits from a data frame representing a message.

20. The method of claim 13, carried out by a communication controller within a microcontroller.
